(19) United States
(12) Patent Application Publication
(10) Pub. No.: US 2005/0059383 A1
(43) Pub. Date: Mar. 17, 2005

(54) Controlled download of data

(75) Inventors: Matthew Murray Williamson, Palo Alto, CA (US); Stuart Philip Stenton, Newport/Berkeley (GB); David Murray Banks, Bristol (GB); James Thomas Edward McDonnell, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett Packard Development Corporation LP, Houston, TX (US)

(21) Appl. No.: 10/874,703

(22) Filed: Jun. 24, 2004

(30) Foreign Application Priority Data
Jun. 25, 2003 (GB) 0314793.1

(51) Int. Cl. H04J 1/16

(52) U.S. Cl. 455/414.1

(57) ABSTRACT

A data item 11 is cyclically broadcast from a wireless transceiver 1 as a number of individual data segments 13. Receipt of all of the individual data segments 13 by a mobile device 9 is required to successfully receive the entirety of the data item 11. The time required to transmit all of the data segments 13 is increased by transmitting each data segment 13 at a minimum time interval from one another, or alternatively or additionally varying the rate of data transmission. A mobile device user is therefore required to remain within the locality of the wireless transceiver 1 for a minimum period of time.

The present invention relates to a method of performing cyclic downloads of data, a receiver for use with such a method and a computer program product for executing the method.

It is known to broadcast data in a cyclic manner. An example of such a cyclic broadcast is the conventional teletext system. Separate packets of teletext data are repeatedly broadcast in a cyclic manner using part of the conventional television transmission signal. For ease of explanation, each packet of data can be thought of as representing a teletext page. Each packet is small and so is capable of being broadcast in a fraction of a second. On entering a required teletext page at the television set, the teletext receiver within the television set monitors the packets of teletext data as they are broadcast in their cyclic manner, and when the required page is reached, the data is displayed on the television screen. The two main advantages of broadcasting cyclic data in this manner is that because the information is broadcast no direct communication channel between the transmitter and receiver needs to be established, thus avoiding the requirement of user logins, and it is possible to broadcast to many individual receivers at once.

It is also becoming increasingly common to use mobile devices, such as conventional GSM mobile telephones, to transmit and receive data other than voice calls. In particular, retailers have realised that advertising media in the form of text messages or animated images, or the like, may be transmitted to mobile telephones to entice or encourage users to purchase goods or services from that retailer. The transmission of such advertising may also be made using other wireless devices, such as those operating using the IEEE 802.11B wireless LAN protocol. The 802.11B protocol enables wireless transmission between devices at speeds in excess of those achievable by conventional GSM cellular telecommunication systems, for example achieving throughput speeds of up to 5 to 6 Mbps. The use of such high speed wireless transmission systems is likely to be more attractive to retailers for the transmission of such advertising because the increased speed permits a wider variety of advertising formats to be transmitted.

As consumers become ever more sophisticated, simple advertising is not considered sufficient to entice consumers towards a particular retailer. It is therefore proposed to broadcast electronic vouchers or credits that may be redeemable at a retailer, or software programs that are executable upon the wireless devices used to receive the transmission, for example ring tones for mobile phones or computer games.

According to a first aspect of the present invention there is provided a method of broadcasting a data item, the method comprising segmenting said data item into a plurality of data segments and broadcasting said plurality of data segments over a transmission channel at an effective data rate less than the data rate supported by said channel, wherein the data segments are organised such that successful receipt of all of said data segments at a receiver is required to acquire or execute said data item and that the time taken to recover all of the data segments is greater than the time normally required to transmit a data object the size of said data item over said channel.

It is therefore possible to provide a method of enticing consumers towards a particular retail outlet with the promise of a downloadable data item and transmitting the data item over a time period longer than actually required on purely technical considerations so as to encourage the consumers to remain at the retail outlet for an extended period of time (at least a “predetermined time”, which can be set or controlled by the retailer).

Preferably, the data segments are assigned an identification code in accordance with a predefined sequence and are broadcast in an order other than said sequence. For example, the data segments may be broadcast in a random order.

Preferably, on receipt of the plurality of data segments, the segments are reassembled in accordance with said sequence.

Additionally or alternatively, the data segments may be encrypted, each data segment including a portion of a decryption key required to decrypt the data segments. It is therefore necessary to receive all of the data segments in order to assemble the decryption key and to decrypt the data segments.

The data segments may comprise an electronic token, the successful acquisition thereof enabling the download of further data item to said receiver.

Preferably, the data segments are broadcast at separate time intervals from one another. For example, each data segment may be broadcast at an interval of 5 minutes, thus extending the time required to receive the complete data items. Additionally, the time interval may be variable. For example, the time interval between each data segment during off peak shopping hours may be shorter than that during peak shopping hours, thus encouraging more shoppers within the retail outlet during off peak hours. Additionally or alternatively, the data rate of the broadcast may be variable. The data rate may be varied in a similar manner to the time interval in accordance with predefined parameters.

Alternatively or additionally, the data rate may vary as a function of the distance of a user from the transmitter. For example, the closer a user is to the transmitter, the higher the data rate is. This encourages users to enter fully within a retail outlet to take advantage of the highest download speed available. Indeed in some embodiments of the invention one of the data items may only be downloadable within the retail outlet such that customers must enter the premises or even purchase something to complete the download.

Preferably, the data segments are broadcast in a substantially directional transmission beam, thereby providing a virtual path to the retail outlet at which the transmitter is located.

There may be provided a receiver comprising a memory and a processor, the receiver being arranged to receive a plurality of data segments and to store said data segments in said memory, wherein the processor is arranged, on receipt of all the data segments, to assemble said plurality of data segments into a complete data item.

Preferably, the receiver is arranged to re-order said data segments in accordance with an identification code included in each of the data segments.

Additionally or alternatively, the receiver is arranged to construct a decryption key from key segments included within said data segments and to decrypt encoded data included in said data segments using the decryption key.

Preferably, the receiver comprises indicator means for providing an indication to a user of the location of the point of transmission of said received data segments.

According to a second aspect of the present invention there is provided a transmitter arranged to operate in accordance with the method according to the first aspect.

According to a third aspect of the present invention there is provided a method of receiving a broadcast data item, the method comprising receiving a plurality of data segments over a transmission channel wherein said data segments are broadcast over the transmission channel at an effective data rate less than the data rate supported by said channel, and the data segments are organised such that successful receipt of all data segments at a receiver is required to acquire or execute said data item and that the time taken to recover all of the data segments is greater than the time normally required to transmit a data object the size of the data item over said channel.

According to a fourth aspect of the present invention there is provided a receiver arranged to operate in accordance with the method according to the third aspect.

According to a fifth aspect of the present invention there is provided a computer program product comprising program code stored on a computer readable carrier, the program code when executed by a processor causing said processor to identify a plurality of received data segments as belonging to a single data item, to assemble a plurality of data segments into a complete data item.

Preferably, the program code causes said computer to reorder said data segments in accordance with an identification code included in each of the data segments.

Additionally or alternatively, the program code causes said computer to construct a decryption key from key segments included within said data segments and to decrypt encoded data included in said data segments using the decryption key.

Preferably, the program code causes said computer to provide an indication to a user of the location of the point of transmission of said received data segments.

According to a sixth aspect of the present invention, there is provided a communication apparatus comprising a wireless receiver, a processor and a memory wherein the memory contains program code which when executed by the processor causes said processor to identify a plurality of data segments received through the wireless receiver as belonging to a single data item, and to assemble such a plurality of data segments into a complete data item.

According to a seventh aspect of the present invention, there is provided a method of rewarding a person for remaining within a predetermined area for a predetermined period of time, wherein the person has possession of a receiver and data processor, comprising providing a transmitter to transmit signals that are receivable within the predetermined area, transmitting signals containing data that has been segmented into a plurality of data segments, wherein the data segments are organised such that successful receipt of all of the segments is required to assemble the data and to make it available to the person as a reward.

According to an eighth aspect of the present invention, there is provided a method of broadcasting a data item, the method comprising determining a minimum customer dwell time, segmenting said data item into a plurality of data segments and broadcasting said plurality of data segments over a transmission channel so that the plurality of data segments are not all transmitted for a period of at least the minimum dwell time, wherein the data segments are organised such that successful receipt of all of said data segments at a receiver is required to acquire or execute said data item.

Embodiments of the present invention are described herein below, for example only, with reference to the accompanying drawings, of which:

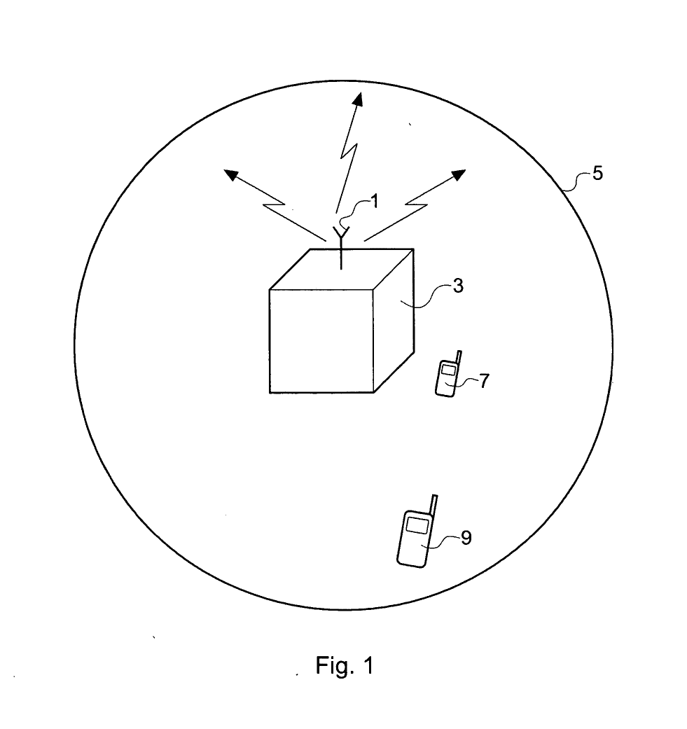

FIG. 1 schematically shows a local wireless transmitter according to embodiments of the present invention;

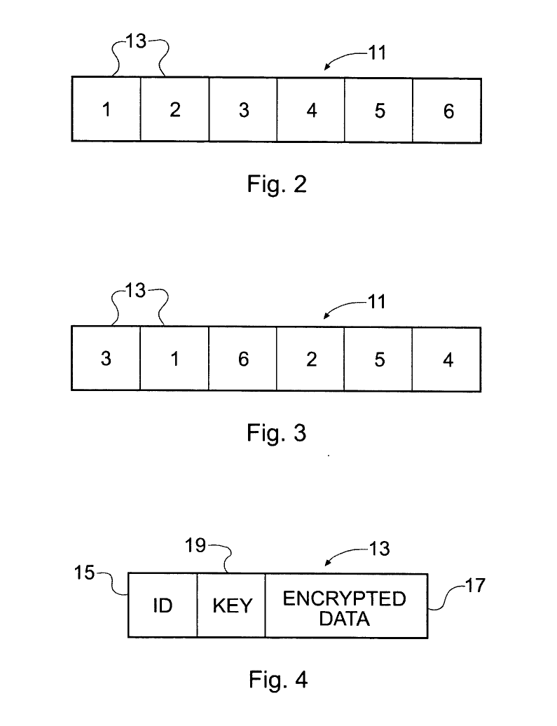

FIG. 2 schematically illustrates the subdivision of a media item into a number of data segments;

FIG. 3 schematically illustrates the data segments shown in FIG. 2 in a rearranged order of transmission;

FIG. 4 schematically illustrates the format of one of the data segments;

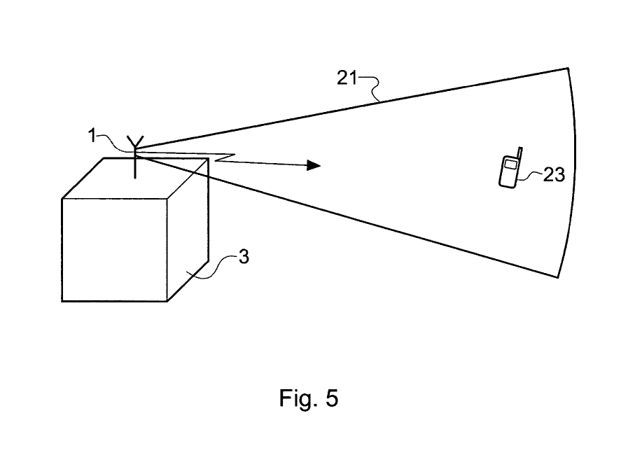

FIG. 5 schematically illustrates the transmission coverage of a local wireless transmitter according to a further embodiment of the present invention;

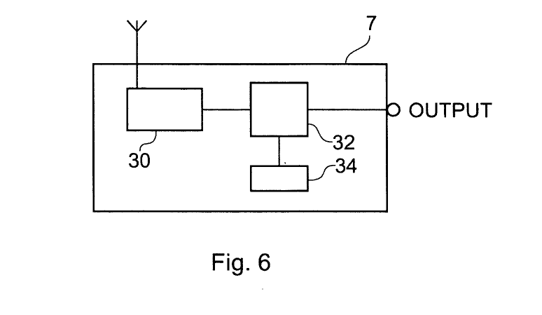

FIG. 6 schematically illustrates a receiver in accordance with the present invention; and

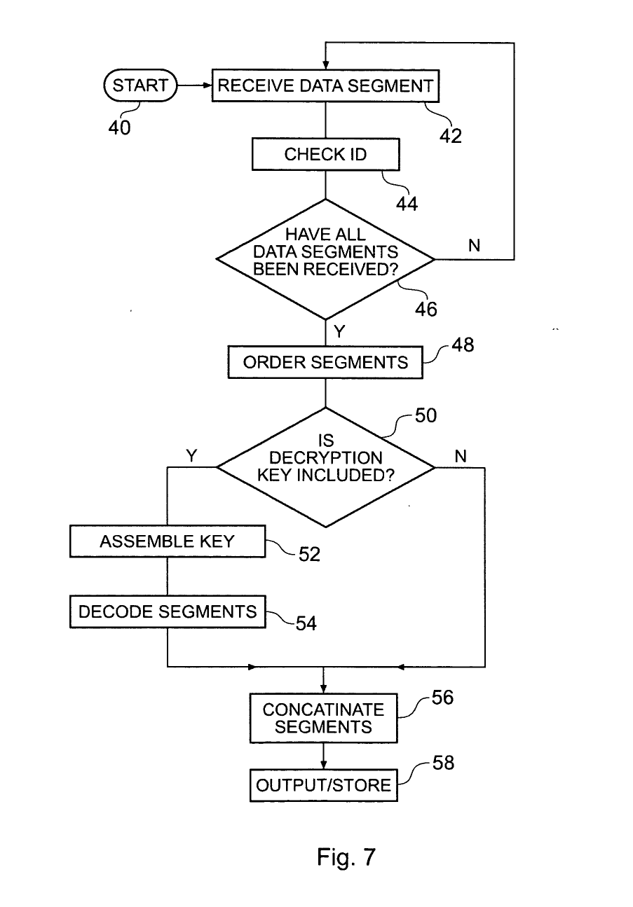

FIG. 7 is a flowchart illustrating the operation of the receiver of FIG. 6.

An embodiment of the present invention is shown in FIG. 1. A wireless transceiver 1 is located at a building 3, which may be a retail outlet. The range of the wireless transceiver 1 is denoted by the solid circle 5 surrounding the building 3. Located within range of the wireless transceiver 1 is a first mobile unit 7 located a relatively short distance from the retail outlet 3, and a second mobile unit 9 located further away from the retail outlet 3 than the first mobile unit 7.

In operation, the wireless transceiver 1 broadcasts a data item. The data item may be an electronic token redeemable within the retail outlet or may be some other data item or executable program that it is anticipated will be of use to the users of mobile devices such as the first and second mobile devices 7, 9. Both the first mobile device 7 and the second mobile device 9 are within range of the wireless transceiver 1 and thus receive the broadcast data item and proceed to process the received broadcast in the manner described herein below.

FIG. 2 schematically illustrates the format of the broadcast data item. The data item 11 is subdivided into a plurality of data segments 13. In the example shown in FIG. 2 there are six data segments. Each data segment is given a unique identification code that identifies the data segment and provides information as to the data segment's position within the entire data item.

Mobile units arranged to operate in accordance with embodiments of the present invention, such as the first and second mobile units 7 and 9 shown in FIG. 1, are illustrated schematically in FIG. 6. Each mobile unit comprises a receiver 30 arranged to receive the data and to make it available to a processor 32 and memory 34 which are arranged to process the individually received data segments so as to reassemble the individual data segments into the complete data item upon successful receipt of all of the individual data segments 13. To achieve this, it is necessary for the mobile devices/receivers to know how many individual data segments there are within the entire data item 11. This may be achieved, for example, by always subdividing a data item into the same predefined number of data segments 13. Alternatively, the total number of data segments 13 within a data item 11 may be variable and this information contained within the identification code included with each data segment 13. As each data segment 13 is received it is stored in the memory and the identification code is read by the processor. If the identification code includes the number of data segments comprising a media item 11, this information is also read by the processor. Once all the data segments have been received, as determined by the processor, the processor concatenates the data segments in the correct order before further processing the media item in its entirety. It will be appreciated by those skilled in the art that other schemes for conveying the total number of data segments 13 within a data item 11 to the mobile devices receiving the broadcast may be envisaged and fall within embodiments of the present invention. It will also be appreciated that the segmentation of the data item in this manner differs significantly from known cyclic transmission schemes. Referring again to the known teletext system, each page is transmitted as a complete data item and is not segmented. Furthermore, according to the present invention the time taken to transmit and recover all of the data segments is deliberately arranged to be greater than the time required to transmit a data item of equal size over the same transmission channel.

An important feature of embodiments of the present invention is that receipt of all of the data segments 13 is required to successfully reconstitute the broadcast data item 11, with the data item 11 being inoperable or unusable unless it has been received in its entirety. This is to encourage mobile device users to remain within the vicinity of the retail outlet 3 that the wireless transceiver 1 is located at for at least a minimum period of time. To increase the minimum period of time required for users to remain within the vicinity of the retail outlet 3 to beyond the time nominally required to receive all of the broadcast data segments 13, one or more transmission schemes are employed in embodiments of the present invention.

FIG. 3 illustrates the format of data segments 13 within a data item 11 according to an embodiment of the present invention that increases the minimum time required for a mobile device user to remain within the vicinity of the retail outlet 3—a minimum customer dwell time.

As in FIG. 2, the data item 11 is subdivided into a number of individual data segments 13. Also as in FIG. 2, individual data segments 13 each carry a unique identification code. When concatenated in the correct order the identification codes of the data segments run, in this example, from 1 to 6 sequentially. However, in the example shown in FIG. 3, the data segments 13 are broadcast sequentially in a random or predefined order such that sequential receipt of the individual data segments 13 does not automatically provide a concatenated sequence of data segments in the correct order. Further processing by the processors within the mobile devices 7, 9 is required to reassemble the received data segments into the correct order. This further enhances the requirement to successfully receive all of the individual data segments to successfully reconstruct the data item in its entirety.

Other ways of increasing the transmission time include transmitting the individual data segments 13 at separate time intervals from one another. For example, a transmission scheme may be arranged such that individual data segments 13 are transmitted at 5 minute intervals from one another. The time interval between the transmission of individual data segments 13 may be fixed, or may be variable. For example, the time interval may vary according to the time of day. For example, at times when the retail outlet expects low customer activity the time interval may be relatively short, so as to encourage mobile device users to within the vicinity of the retail outlet on the expectation of receiving the media/data item in a relatively short period of time. Conversely, at times when customer activity is expected to be high, a relatively long time interval may be set between transmission of each data segment 13.

Additionally or alternatively the actual data rate of transmission of the data item 11 may be varied. For example, as a mobile device moves towards the wireless transceiver 1, the data transmission rate may increase. Thus a mobile device user is encouraged to move as close as possible, and preferably within, the retail outlet 3 at which the wireless transceiver 1 is located to receive the broadcast data item 11 within the shortest possible period of time. The wireless transceiver 1 may be configured to alter the transmission rate in accordance with the range of the mobile device, or the variation in data transmission rate may occur automatically. For example, the wireless transceiver 1 may be part of a wireless LAN operating in accordance with the IEEE 802.11B transmission protocol that automatically increases the rate of data transmission as a mobile device moves closer to the transmitter.

In other embodiments of the present invention each data segment 13 may be repeatedly transmitted a number of times before the next data segment within the transmission sequence is transmitted. This therefore increases the overall transmission time for transmitting all of the data segments 13.

Other schemes for ensuring that the entirety of a data item 11 must be received in order for the data item to be successfully downloaded are included within embodiments of the present invention. One such scheme involves the encryption of the data contained within the data segments 13. FIG. 4 schematically illustrates the data format of a data segment 13 utilising data encryption. The data segment 13 includes an identification code segment 15 that includes the identification code of the data segment 13 as previously discussed. Also included within the data segment 13 is a data payload segment 17 that contains encrypted data. Also included within the data segment 13 is a decryption key segment 19 that includes a portion of the key required to decrypt the data contained within the data payload segment 17. Only on receipt of the entirety of the data segments 13 that comprise the data item 11 is it possible to fully reconstruct the decryption key from the individual key segments 19. Only with the complete decryption key may the data within the payload segments 17 be successfully decrypted. Hence a mobile device user must remain within range of the wireless transceiver 1 for at least a period of time necessary to receive all of the data segments to ensure successful receipt of the data item 11.

Referring to FIG. 5, a further embodiment of the present invention is schematically illustrated. As in the embodiment shown in FIG. 1, a wireless transceiver 1 is located at a retail outlet 3. However, the transmission range and envelope of the wireless transceiver 1, indicated by the solid line 21, is similar in shape to a segment from a circle, as opposed to a complete circle as shown in FIG. 1. Thus the media items broadcast from the wireless transceiver 1 are broadcast in substantially a single direction only. This permits a third wireless device 23 that incorporates an indicator of the received signal strength to provide some directional information to the mobile device user as to the range and location of the retail outlet 3. In this manner, the transmission envelope 21 of the wireless transceiver 1 is arranged to form a virtual path leading to the retail outlet 3. This makes it easier for a mobile device user to locate the retail outlet 3, thus increasing the likelihood of the mobile device user persisting with receipt of the data item 11 and remaining within the vicinity of the retail outlet 3.

In a further embodiment the segmented data item 11 comprises an electronic token, or password, that may be used to enable a further data item, such as an executable computer program, to be downloaded from the wireless transceiver 1 to one of the mobile devices 7, 9. The download of the further data item is accomplished in a conventional manner. The download of the further data item may occur automatically on the successful receipt of the entire token or password, or may require user intervention to transmit the token back to the wireless transceiver 1.

FIG. 7 schematically illustrates a flowchart detailing the steps performed within the mobile unit illustrated in FIG. 6. Commencing at step 40, control is passed to step 42 where a check is made to see if a data segment has been received. Once a data segment has been received control is passed to step 44 where the identification field of the data segment is examined in order to ascertain the data segment's ID. From step 44 control is passed to step 46 where a test is made to see if all the data segments have been received. If they have not control is returned to step 42, otherwise control is passed to step 48 wherein the data segments are reordered into the correct sequence. From step 48 control is passed to step 50 where a test is made to see if the data segments include an encryption key. If they do, control is passed to step 52 where the data segments are examined to obtain the decryption key and the decryption key is then assembled. From step 52 control is passed to step 54 where the data within the data segments is decrypted. From step 54 control is passed to step 56 where the data segments are concatenated and then output or stored at step 58. Returning to step 50, if a decryption key is not included then control is passed directly from step 50 to step 56. Thus all the segments need to be received before the data item, whether it be a token, a voucher an item of entertainment or an executable file, or indeed any other data, must be received in its entirety before it can be used.

In some embodiments of the present invention the wireless transceiver 1 may be a conventional radio transmitter. In this case the data items 11 may be transmitted in a sideband of a transmitted radio channel and may be a music item, such as the latest release of a chart record, the time delayed downloading of which provides an incentive for radio listeners to remain tuned to the particular radio station broadcasting the media item.

The present invention therefore provides a solution to the apparent conflict of utilising transmission technology having improved transmission speeds whilst encouraging users to remain within the transmission range for at least a minimum period of time.

1. A method of broadcasting a data item, the method comprising segmenting said data item into a plurality of data segments and broadcasting said plurality of data segments over a transmission channel at an effective data rate less than the data rate supported by said channel, wherein the data segments are organised such that successful receipt of all of said data segments at a receiver is required to acquire or execute said data item and that the time taken to recover all of the data segments is greater than the time normally required to transmit a data object the size of said data item over said channel.

2. A method according to claim 1, wherein the data item is broadcast cyclically.

3. A method according to claim 1, wherein said data segments are assigned an identification code in accordance with a predefined sequence and are broadcast in an order other than said sequence.

4. A method according to claim 1, wherein said data segments are encrypted, each data segment including a portion of a decryption key required to decrypt said data segments.

5. A method according to claim 1, wherein said data segments comprise an electronic token, the successful acquisition thereof enabling the transmission of a further data item to said receiver.

6. A method according to claim 1, wherein said data segments are broadcast discretely, with successive broadcasts separated by a time interval.

7. A method according to claim 6, wherein said time interval is variable.

8. A method according to claim 1, wherein the rate of data broadcast is variable.

9. A method according to claim 8, wherein the method further comprises determining a distance to the receiver, and varying said data rate as a function of the distance to said receiver.

10. A method according to claim 1, wherein said data segments are broadcast in a substantially directional transmission beam.

11. A transmitter arranged to operate in accordance with the method of claim 1.

12. A method of receiving a broadcast data item, the method comprising receiving a plurality of data segments over a transmission channel wherein said data segments are broadcast over the transmission channel at an effective data rate less than the data rate supported by said channel, and the data segments are organised such that successful receipt of all data segments at a receiver is required to acquire or execute said data item and that the time taken to recover all of the data segments is greater than the time normally required to transmit a data object the size of the data item over said channel.

13. A method according to claim 12, wherein said data segments are associated with an identification code in accordance with a predefined sequence and are broadcast in an order other then said sequence, and the method further comprises reassembling said data items in accordance with said sequence.

14. A method according to claim 12, further comprising determining a portion of a decryption key from each of the plurality of data segments, and decrypting the data segments using the decryption key.

15. A receiver arranged to operate in accordance with the method according to claim 12.

16. A computer program product comprising program code stored on a computer readable carrier, the program code when executed by a processor causing said processor to identify a plurality of received data segments as belonging to a single data item, and to assemble said plurality of data segments into a complete data item.

17. A computer program product according to claim 16, wherein the program code causes said processor to reorder said data segments in accordance with an identification code included in each of the data segments.

18. A computer program product according to claim 16, wherein the program code causes said processor to construct a decryption key from key segments included within said data segments and to decrypt encoded data included in said data segments using the decryption key.

19. A computer program product according to claim 16, wherein said program code causes said processor to provide an output for indication to a user of the location of the point of transmission of said received data segments.

20. A communication apparatus comprising a wireless receiver, a processor and a memory wherein the memory contains program code which when executed by the processor causes said processor to identify a plurality of data segments received through the wireless receiver as belonging to a single data item, and to assemble such a plurality of data segments into a complete data item.

21. A method of rewarding a person for remaining within a predetermined area for a predetermined period of time, wherein the person has possession of a receiver and data processor, comprising providing a transmitter that transmits signals over a transmission channel that are receivable within the predetermined area, transmitting signals containing a data item that has been segmented into a plurality of data segments, and wherein the data segments are organised such that successful receipt of all of the segments by the receiver is required to assemble the data item and to make it available to the person as a reward.

22. A method as claimed in claim 21, wherein said data segments comprise an electronic token, the successful acquisition thereof enabling the transmission of a further data item to the receiver.

23. A method as claimed in claim 21, wherein the transmitter transmits the data item at an effective data rate less than the data rate supported by said channel.

24. A method as claimed in claim 21, wherein the item taken to transmit the data item is greater than the time normally required to transmit a data object the size of said data item over said channel.

25. A method of broadcasting a data item, the method comprising determining a minimum customer dwell time, segmenting said data item into a plurality of data segments and broadcasting said plurality of data segments over a transmission channel so that the plurality of data segments are not all transmitted for a period of at least the minimum dwell time, wherein the data segments are organised such that successful receipt of all of said data segments at a receiver is required to acquire or execute said data item.

26. A method according to claim 25, wherein the data item is broadcast cyclically.

27. A method according to claim 25, wherein said data segments are assigned an identification code in accordance with a predefined sequence and are broadcast in an order other than said sequence.

28. A method according to claim 25, wherein said data segments are encrypted, each data segment including a portion of a decryption key required to decrypt said data segments.

29. A method according to claim 25, wherein said data segments comprise an electronic token, the successful acquisition thereof enabling the transmission of a further data item to said receiver.

30. A method according to claim 25, wherein said data segments are broadcast discretely, with successive broadcasts separated by a time interval.

31. A method according to claim 30, wherein said time interval is variable.

32. A method according to claim 25, wherein the rate of data broadcast is variable.

33. A method according to claim 32, wherein the method further comprises determining a distance to the receiver, and varying said data rate as a function of the distance to said receiver.

34. A method according to claim 25, wherein said data segments are broadcast in a substantially directional transmission beam.
